(19) United States
(12) Patent Application Publication
(10) Pub. No.: US 2012/0228533 A1
(43) Pub. Date: Sep. 13, 2012

(54) DEVICE FOR THE FLOW CONTROL OF A LIQUID OR GASEOUS MEDIUM

(76) Inventors: Felix Ams, Kaempfelbach (DE); Stefan Wegehingel, Pforzheim (DE); Matthieu Clemente, Bretten (DE)

(21) Appl. No.: 13/108,581

(22) Filed: May 16, 2011

(30) Foreign Application Priority Data
Mar. 12, 2011 (EP) 11 002 067.4

(51) Int. Cl. F16K 31/08; F16K 31/02

(52) U.S. Cl. 251/129.03; 251/129.15

(57) ABSTRACT

A device for a flow control of a liquid or gaseous medium, in particular for metering a fluid to be admixed into an exhaust gas treatment system, contains an electromagnet which has a solenoid coil with a magnetic core and an end-side magnetic plate in a magnet housing, and actuates a valve element in a valve compartment of a valve body to control a valve seat located there. The solenoid coil is protected against deformation with respect to the valve compartment, and is sealed using a sealing device.

### CROSS-REFERENCE TO RELATED APPLICATION

The invention described and claimed hereinbelow is also described in European Patent Application EP 11 002 067.4 filed on Mar. 12, 2011. This European Patent Application, whose subject matter is incorporated here by reference, provides the basis for a claim of priority of invention under 35 U.S.C. 119(a)-(d).

### BACKGROUND OF THE INVENTION

The invention relates to a device for the flow control of a liquid or gaseous medium, in particular for metering a fluid to be admixed into an exhaust gas treatment system, comprising an electromagnet which has a solenoid coil with a magnetic core and an end-side magnetic plate in a magnet housing, and actuates a valve element in a valve compartment of a valve body to control a valve seat located there.

Devices of this type are known (DE 10 2004 025 062 B4), in the case of which the valve element is composed of a long plunger in the form of a magnetic core disposed inside a solenoid coil. A metering valve of this type should be freeze-resistant if it is intended for use in an SCR exhaust gas treatment device, wherein a reductant, in particular a urea-water solution, is used as the medium to be controlled. Due to the high water content of the solution, the solution—which is pressurized during operation—freezes even at relatively low negative Celsius degrees, e.g. at approximately minus 11° Celsius. Volume is thereby reduced by approximately 10%, for example. As a result, the device—as well as the electromagnet and the metering valve—can become damaged or even destroyed.

### SUMMARY OF THE INVENTION

The problem addressed by the invention is that of creating a device of the initially stated type, which is freeze-resistant and is not damaged or destroyed even at negative temperatures accompanied by volumetric expansion of a water-containing solution. In any case, the device should be simple and low-cost.

The problem is solved according to the invention in the case of a device of the initially stated type in that the solenoid coil is protected against deformation with respect to the valve chamber. The solenoid coil is therefore protected against deformations caused by an increase in the volume of the medium that occurs at frost temperatures. The risk of any damage occurring to the soft solenoid coil or even destruction thereof is ruled out.

It can be particularly advantageous for the solenoid coil to be sealed with respect to the valve compartment using a sealing device. Medium in the valve compartment is thereby prevented from reaching the solenoid coil.

The sealing device can comprise a seal which is disposed between the solenoid coil and the magnetic coil and/or the magnetic plate, and is designed as a circumferential seal around the magnetic core.

This sealing device can comprise two seals, i.e. at least a first seal which is designed as a radial seal and is disposed between the solenoid coil and the magnetic core, and at least one second seal which is designed as an axial seal and is disposed between the solenoid coil and the magnetic plate.

The sealing device advantageously comprises a metallic seal holder which is disposed between the solenoid coil and the magnetic core and the magnetic plate, and accommodates the at least one seal situated between the solenoid coil and the magnetic plate and/or the magnetic core. The metallic, hard seal holder functions as a protective plate with respect to the solenoid coil. It also holds the seals.

The seal holder can comprise an annular part which encloses the magnetic core, abuts the solenoid coil, and contains a radial seal which rests against the magnetic core, wherein the annular part can be designed as a cylindrical sleeve, for example. The seal holder can comprise an axial annular part which extends axially between the solenoid coil and the magnetic plate, and contains the axial seal which rests against the magnetic plate.

The axial annular part advantageously abuts the cylindrical sleeve and is integral therewith. In that particular case, the cylindrical sleeve accommodates the radial seal which rests against the solenoid armature, and the axial annular part accommodates the axial seal which rests against the magnetic plate. The solenoid coil is therefore reliably sealed with respect to the valve compartment using two seals, i.e. a radial seal and an axial seal.

The seal holder can be designed as a ring having an approximately U-shaped cross section, wherein the base of the “U” rests against the solenoid coil, the inner leg of the “U” forms the cylindrical sleeve enclosing the solenoid armature, and the outer “U” leg extends axially between the solenoid coil and the magnetic plate.

It can be advantageous for the valve compartment to be disposed between the magnetic plate and a valve body containing the valve seat, and to be sealed against the outside using a seal disposed therebetween. Advantageously, the inlet opening of at least one inlet channel and the outlet opening of at least one preferably central outlet channel lead into the valve compartment.

It can be advantageous for the valve element to comprise a low-mass, flat armature in the valve compartment between the magnetic plate and the valve body. The flat armature can comprise a central armature disk, as the actuatable valve element, which is connected in a movable manner via resilient legs. Advantageously, the resilient legs can be designed as return springs. Due to this design, the metering valve can switch rapidly, e.g. it can open and close in fewer than 5 msec. If a downstream injection nozzle is present, it is thereby ensured that injection will take place cleanly, without fluid dribble before or after injection.

Advantageously, the armature disk can comprise a sealing plate on the side facing the valve seat, and at least one damping element on the opposite side. The at least one damping element can be part of the sealing plate which is composed of elastic material, such as an elastomer

The valve seat can be designed as an overhanging, approximately blade-like annular seat.

Furthermore, it can be advantageous for at least one spring, e.g. a cylindrical coil spring, which is accommodated in the magnetic core, for example, to act on the magnetic core. This spring can be supported and centered on the magnetic core on one side, and on the valve element on the other side, wherein this spring is designed as a closing spring and is used to apply a specified counterpressure. As a result, the return speed of the metering valve is increased further.

According to a further advantageous embodiment, the outlet channel which leads into the opening in the valve seat is sealed, using an axial seal, at the end of the valve body relative to a receptacle in a housing which contains an adjacent fluid outlet.

The at least one inlet channel of the valve body can be connected to the at least one supply channel in the valve body, which is connected to a fluid inlet of the housing.

It can be advantageous for the valve body to contain a circumferential seal, e.g. a sealing ring, in a respective annular groove on either axial side of the supply channel, to seal the valve body with respect to the receptacle in the housing, into which the valve body has been inserted. These seals provide a reliable seal against the outside and between the fluid inlet and the fluid outlet.

The valve body can have a stepped design and, in the axial region extending above the supply channel, can have a larger diameter than in the axial region extending below the supply channel. As a result, if ice should form and the volume increases, a resulting force that acts in the direction of forcing the device out of the housing can act upon a relatively large surface area and push the device out of the housing against the action of a counterspring. Any damage to the valve is thereby prevented.

The device is suited to particular advantage for the metering of reductants, in particular a urea-water solution, for an SCR exhaust gas treatment device. Injection nozzles combined with metering valves are used in exhaust systems to meter such reductants. The device according to the invention is well suited for such an application without the risk of damage. The metering valve is not damaged if the solution should freeze and thereby undergo a ten-percent increase in volume. It also ensures good injection/spraying and reliable sealing against the outside in the non-frozen state. Due to the low mass of the valve element, the metering valve is capable of opening and closing in fewer than 5 msec, and can therefore switch very rapidly. Clean injection via the injection nozzles is ensured as a result. Due to the axial seal on the end of the valve body relative to the housing, a connection devoid of air inclusions is ensured between the device and the fluid outlet of the housing. The solenoid coil of the electromagnet, as a relatively soft component, is protected against damage. The metallic seal holder is used as mechanical protection. In addition, due to the at least one radial seal, the medium which is located and controlled in the valve chamber is unable to enter the region of the solenoid coil, thereby preventing same from applying destructive force to the solenoid coil if freezing and, therefore, an increase in volume, should occur.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTON OF THE DRAWINGS

FIG. 1 shows a schematic and simplified longitudinal view of a device for the flow control of a liquid or gaseous medium, according to a first embodiment,

FIG. 2 shows a section of a detail of the device depicted in FIG. 1, on a larger scale,

FIG. 3 shows a top view of a detail of the device depicted in FIG. 1,

FIG. 4 shows a schematic section based on the view shown in FIG. 2 of a detail of a device according to a second embodiment.

### DESCRIPTION OF THE PREFERRED EMBODIMENTS

The drawings show a device 10 for the flow control of a liquid or gaseous medium, wherein device 10 is designed in particular for the metering of a fluid to be admixed into an exhaust gas treatment system. Device 10 comprises an electromagnet 11, to which an electric plug connector 12 is connected. Electromagnet 11 comprises a solenoid coil 14 with a magnetic core 15 and an end-side magnetic plate 16 in a magnet housing 13. Electromagnet 11 is designed to actuate a freeze-resistant metering valve 17 comprising a valve element 18 in a valve compartment 19 of a valve body 20 to control a valve seat 21 located there. Valve body 20 is inserted into a receptacle 22 of a housing 23 which contains a fluid inlet 24 and a fluid outlet 25. A spring 26, which is shown schematically, generates a spring force which is used to hold metering valve 17 pressed into receptacle 22 of housing 23 with a specified force by way of electromagnet

In particular when such devices 10 are used to meter reductants, in particular urea-water solutions, e.g. for SCR exhaust gas treatment devices, metering valve 17 must be designed to be freeze-resistant in particular, because, due to the high water content of a urea-water solution, the solution—which is pressurized during operation—freezes even at low negative ° Celsius, e.g. at minus 11° Celsius, wherein this solution expands by approximately 10%, for example. Due to this behavior, metering valve 17 must be designed such that it is not damaged and also exhibits good injection/spraying behavior, and such that reliable sealing against the outside is ensured. In the case of typical valves, the fluid controlled by valve element 18 can also enter the region of solenoid coin 14. In the control of an above-described fluid, solenoid coil 14, as a relatively soft component, would become deformed and therefore damaged if freezing would occur, accompanied by the increase in volume by approximately 10%. As a countermeasure, solenoid coil 14 is protected against deformation with respect to valve compartment 19.

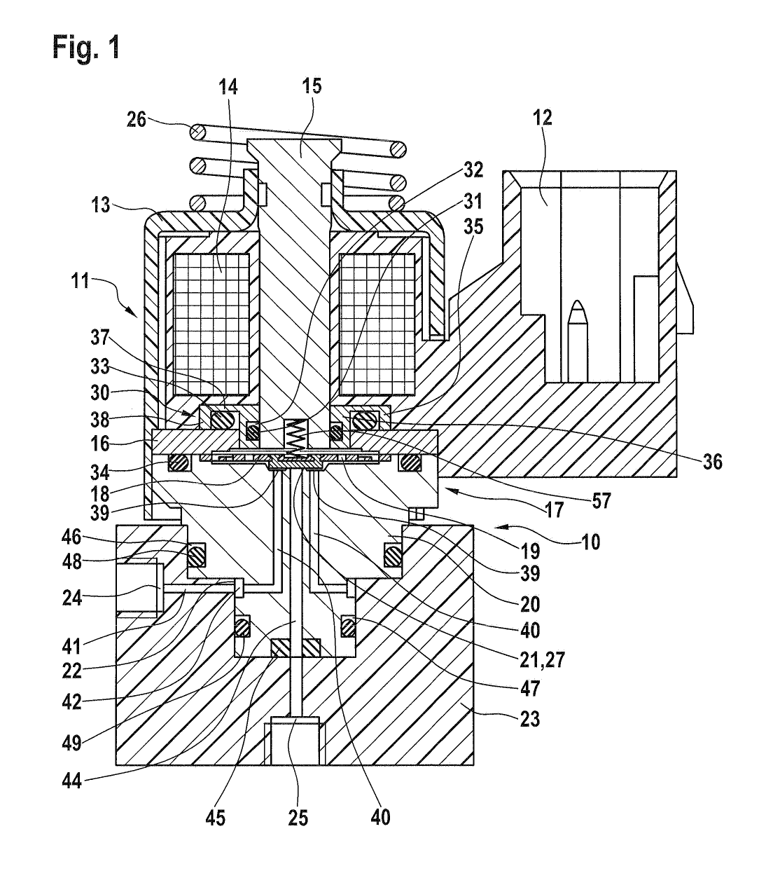

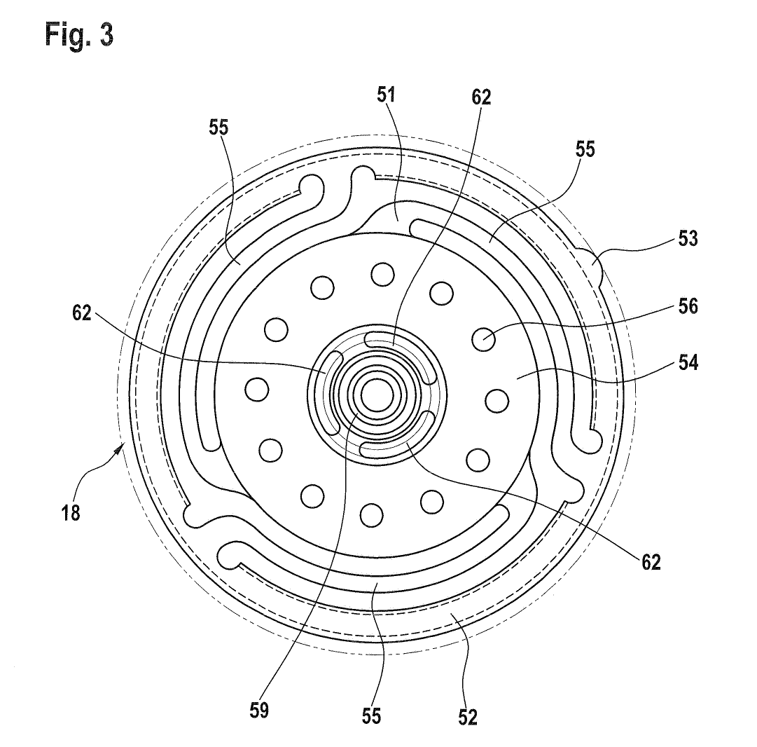

Solenoid coil 14 is sealed with respect to valve compartment 19 using a sealing device 30, thereby preventing fluid from even reaching the region of solenoid coil 14. Sealing device 30 comprises a seal 31 which is disposed between solenoid coil 14 and magnetic core 15 and/or magnetic plate 16, and is designed as a circumferential seal around magnetic core 15. In the first embodiment depicted in FIGS. 1 to 3, seal 31 is a first seal which is provided between solenoid coil 14 and magnetic core 15 and is designed as a radial seal which is situated in an annular groove 32 of magnetic core 15. Furthermore, in the first embodiment according to FIGS. 1 to 3, sealing device 30 comprises at least one second seal 33 which is disposed between solenoid coil 14 and magnetic plate 16, and is designed as an axial seal. Valve compartment 19 formed between magnetic plate 16 and valve body 20 is sealed against the outside using a seal 34 disposed between magnetic plate 16 and valve body 20. Seals 31, 33, and 34 are each in the form of O rings.

Sealing device 30 comprises a metallic seal holder 35 disposed between solenoid coil 14 and magnetic core 15 and magnetic plate 16, wherein seal holder 35 accommodates at least one of the seals 31, 33, and both seals 31, 33 in the first embodiment. Seal holder 35 comprises an annular part 36 which encloses magnetic core 15, abuts solenoid coil 14, and contains radial seal 31 which bears against magnetic core 15. Annular part 36 is designed as a cylindrical sleeve. Seal holder 35 furthermore comprises an axial annular part 37 which extends axially between solenoid coil 14 and magnetic plate 16, and contains axial seal 33 which bears against magnetic plate 16. Axial annular part 37 abuts annular part 36 in the form of the cylindrical sleeve, and is integral therewith. Seal holder 35 is designed as a ring having an approximately U-shaped cross section, wherein the base of the “U” bears against solenoid coil 14, the inner leg of the “U” forms the cylindrical sleeve enclosing solenoid armature 15, and outer “U” leg 38 extends axially between solenoid coil 14 and magnetic plate 16. In this manner, relative soft solenoid coil 14 is covered and protected by metallic seal holder 35, and is sealed reliably by seals 31 and 33 with respect to valve compartment 19 through which the fluid flows, and so if the fluid should freeze at low external temperatures and thereby undergo volumetric expansion, it is captured by seal holder 35, and the fluid is kept away from solenoid coil 14 by seals 31, 33 and is prevented from acting on solenoid coil 14 and possibly deforming same.

Inlet openings 39 of three inlet channels 40, for example, which are connected to at least one supply channel 41 in valve body 20 by an annular channel 42, lead into valve compartment 19. Supply channel 41 is connected to fluid inlet 24. Furthermore, at least one outlet opening 43 of at least one preferably central outlet channel 44, which is connected to fluid outlet 25, leads into valve chamber 19.

Valve seat 21 is designed as overhanging, approximately blade-like annular seat 27, wherein outlet opening 43 leads into the opening of annular seat 27. Outlet channel 44 is sealed at the lower end of valve body 20 with respect to housing 23 using an axial seal 45. Valve body 20 has a stepped design. In the axial region extending above supply channel 41, it has a larger diameter than in the axial region extending below supply channel 41. On either axial side of supply channel 41, valve body 20 contains a circumferential seal 48, 49, e.g. a sealing ring, in an annular groove 46, 47, respectively, for sealing valve body 20 with respect to receptacle 22 in housing 23.

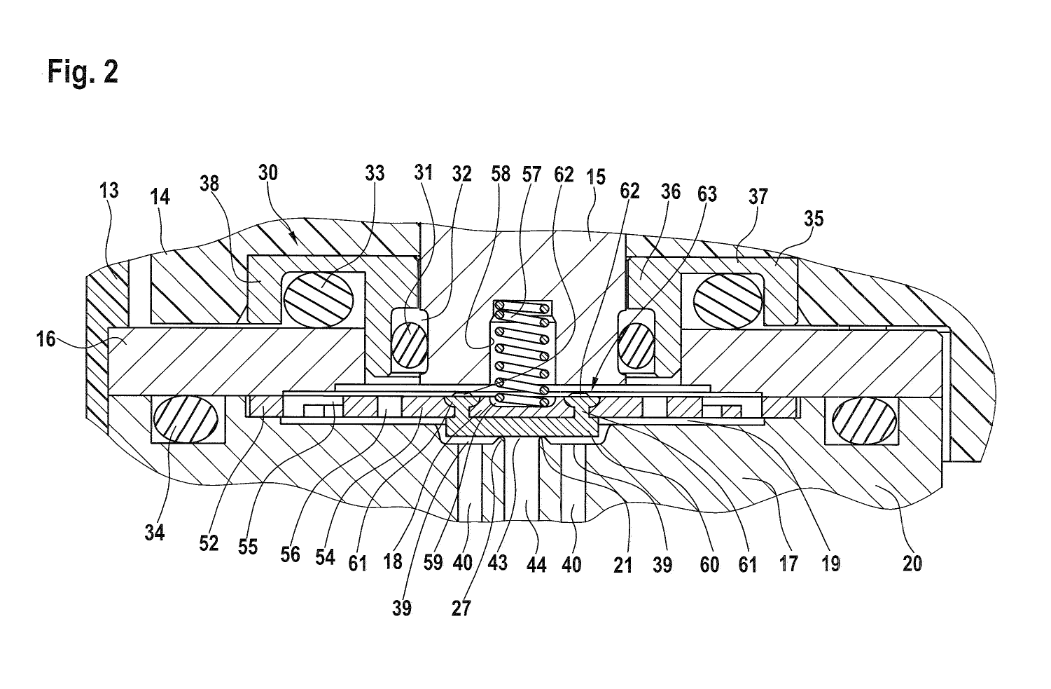

Valve element 18 comprises a low-mass, flat armature 51 in valve compartment 19 between the magnetic plate and valve body 20. Flat armature 51 is part of the magnetic circuit of electromagnet 11 and is drawn inwardly and moved upwardly upon excitation of solenoid coil 14 depicted in FIGS. 1 and 2, thereby lifting valve element 18 off of valve seat 21 and allowing the fluid to pass from inlet channels 40 via particular inlet opening 39 and valve compartment 19 into outlet opening 43 and to outlet channel 44. Flat armature 51 comprises an outer ring 52 which is held between magnetic plate 16 and valve body 20, wherein a radial projection 53 serves as a rotation-prevention means. Furthermore, flat armature 51 comprises a central armature disk 54 which is connected to ring 52 via curved, resilient legs 55, and is movable relative thereto. Armature disk 54 is the movable element of valve element 18 which controls the valve passage. Armature disk 54 comprises holes 56 for fluid equalization. Resilient legs 55 generate a resilient restoring force in the closing direction and closing position depicted in FIG. 2. They function as return springs during valve actuation. At least one spring 57 is contained in magnetic core 15 at the lower end thereof, and is designed as a cylindrical coil spring, for example. Spring 57 is held in a hole 58 in magnetic core 15 and is centered therein. Spring 57 is supported at the other end thereof on valve element 18, where it is accommodated and centered in a recess 59. Spring 57 is designed as a closing spring and is used to apply a specified counterpressure. In addition to resilient legs 55 of armature disk 54, it helps to increase the switch-back speed of metering valve 17.

On the side facing valve seat 21, armature disk 54 comprises a sealing plate 60 which, in the closed position, is seated on annular seat 27 and performs a sealing function. Sealing plate 60 rests on the underside of armature disk 54. Sealing plate 60 is connected to armature disk 54 via e.g. three posts 61 which are integral with sealing plate 60 and extend through armature disk 64, wherein posts 61 extend past the top side of armature disk 54 by way of curved sections and form respective damping elements 63. Sealing plate 60 is integral with posts 61 and is composed of elastic material, e.g. an elastomer.

Metering valve 17 is shown in the closed position in FIGS. 1 and 2. When solenoid coil 14 is excited and a magnetic circuit is created, it moves armature disk 54 upward, as indicated in FIGS. 1 and 2, against the action of spring 57 and resilient legs 55. Posts 61 and sections 62 function thereby as damping elements 63 which dampen a potential impact against magnetic core 15 in the course of this motion. Spring 57 is thereby compressed. Upon de-excitation of solenoid coil 14, valve element 18 closes abruptly and preferably within fewer than 5 msec, due to the restoring force of spring 57 and resilient legs 55 of armature disk 54. Device 10 has the advantage that metering valve 17 can open and close in a short period of time, e.g in fewer than 5 msec, thereby ensuring that the supplied fluid—which is under a pressure of 8 bar, for example—is injected cleanly and reproducibly, without fluid dribble before or after injection. It is thereby ensured that the fluid, in particular the reductant, contains no air inclusions at the valve outlet of outlet channel 44, which would otherwise cause fluid dribble after injection. Solenoid coil 14 is covered and protected against deformation by metallic seal holder 35 and by magnetic plate 16 for the rest. Furthermore, solenoid coil 14 is sealed in a freeze-resistant manner with respect to valve compartment 19 using sealing device 30, which is composed of seal holder 35 having first radial seal 31 and second axial seal 33, thereby preventing fluid from valve compartment 19 from reaching solenoid coil 14, which could otherwise deform solenoid coil 14 if freezing and, therefore, volumetric expansion would occur. Solenoid coil 14 is therefore protected against freezing.

Circumferential seal 48 provides a freeze-resistant seal against the outside. Circumferential seal 49 provides a freeze-resistant seal between fluid inlet 24 with supply channel 41 and fluid outlet 25 with outlet channel 44, wherein axial seal 45 on the lower end of valve body 20 is used as an axial seal to prevent air inclusions. Axial seal 45 ensures that the connection between outlet channel 44 and fluid outlet 25 is free of air inclusions. Such a seal is required only in the non-frozen state since metering takes place using metering valve 17 only in this state. If a fluid, which is controlled as a reductant, should collect in the region between receptacle 22 and valve body 20 and freeze if temperatures drop below zero, thereby increasing in volume, the unit composed of electromagnet 11 and metering valve 17 can be pushed axially out of housing 23 against the action of spring 26 and thereby get out of the way without metering valve 17 becoming damaged or even destroyed. Device 10 is therefore suited to particular advantage for controlling a medium in the form of a reductant, in particular a urea-water solution, for an SCR exhaust gas treatment device. It is thereby ensured that damage will not occur even if freezing should occur, and that good injection/spraying can take place, and that a reliable seal against the outside is provided. Since valve element 18 in the form of flat armature 51 has a very low mass, metering valve 17 makes rapid switching possible, i.e. rapid switching between opening and closing, wherein opening and closing can take place in fewer than 5 sec, for example, thereby resulting in clean injection of the fluid through an injection nozzle.

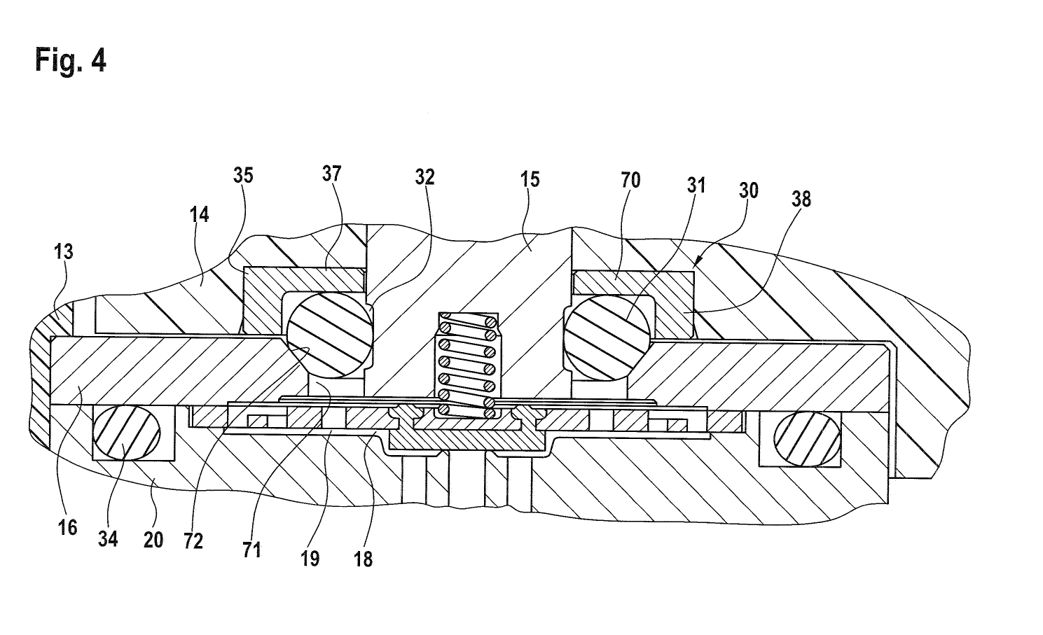

In the second embodiment, shown in FIG. 4, the same reference symbols are used for the components that correspond to those in the first embodiment, and so reference is made to the description of the first embodiment, to avoid repetition.

The second embodiment according to FIG. 4 differs from the first embodiment in that only one seal 51, which is designed as a radial seal, is provided between solenoid coil 14 and magnetic core 15 and magnetic plate 16. Seal holder 35 comprises only axial annular part 37 which is designed as annular disk 70 having adjacent outer leg 38 which extends approximately axially parallel between solenoid coil 14 and magnetic plate 16. Magnetic plate 16 comprises a central opening 71 and, in the region thereof, contains a recess 72 which is shaped approximately as a truncated cone, as the mating surface for radial seal 31. A reliable seal of solenoid coil 14 with respect to valve compartment 19 is ensured in this simplified embodiment of sealing device 30 as well.

It will be understood that each of the elements described above, or two or more together, may also find a useful application in other types of constructions differing from the types described above.

While the invention has been illustrated and described as embodied in a device for the flow control of a liquid or gaseous medium, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A device for a flow control of a liquid or gaseous medium, comprising an electromagnet which has a solenoid coil with a magnetic core and an end-side magnetic plate in a magnet housing, and actuates a valve element in a valve compartment of a valve body to control a valve seat, wherein the solenoid coil is protected against deformation with respect to the valve compartment.

2. The device according to claim 1, wherein the solenoid coil is sealed with respect to the valve compartment (19) with a sealing device.

3. The device according to claim 2, wherein the sealing device comprises a seal which is disposed between the solenoid coil and an element selected from the group consisting of the magnetic core, the magnetic plate, and both, and is a circumferential seal around the magnetic core.

4. The device according to claim 2, wherein the sealing device comprises a first seal which is a radial seal and is disposed between the solenoid coil and the magnetic core, and at least one second seal which is an axial seal and is disposed between the solenoid coil and the magnetic plate.

5. The device according to claim 2, wherein the sealing device comprises a metallic seal holder which is disposed between the solenoid coil and the magnetic core and the magnetic plate, and accommodates at least one seal situated between the solenoid coil and an element selected from the group consisting of the magnetic plate, the magnetic core, and both.

6. The device according to claim 5, wherein the seal holder has an annular part which encloses the magnetic core, abuts the solenoid coil, and contains a radial seal which rests against the magnetic core.

7. The device according to claim 6, wherein the annular part is a cylindrical sleeve.

8. The device according to claim 5, wherein the seal holder has an axial annular part which extends axially between the solenoid coil and the magnetic plate, and contains an axial seal which rests against the magnetic plate.

9. The device according to claim 7, wherein the axial annular part abuts the cylindrical sleeve and is integral therewith, wherein the cylindrical sleeve accommodates the radial seal which rests against a solenoid armature, and the axial annular part accommodates an axial seal which rests against the magnetic plate.

10. The device according to claim 5, wherein the seal holder (35) is a ring having a substantially U-shaped cross section, wherein a base of a “U” rests against the solenoid coil, an inner leg of the “U” forms a cylindrical sleeve enclosing a solenoid armature, and an outer “U” leg extends axially between the solenoid coil and the magnetic plate.

11. The device according to claim 1, wherein the valve compartment is disposed between the magnetic plate and the valve body containing the valve seat and is sealed against an outside using a seal disposed therebetween, wherein an inlet, opening of at least one inlet channel and an outlet opening of at least one outlet channel lead into the valve compartment.

12. The device according to claim 1, wherein the valve element has a low-mass, flat armature in the valve compartment between the magnetic plate and the valve body.

13. The device according to claim 12, wherein the flat armature has a central armature disk, as the valve element, which is connected in a movable manner via resilient legs, and the resilient legs are return springs.

14. The device according to claim 1, wherein an armature disk has a sealing plate on the side facing a valve seat, and has at least one damping element on an opposite side.

15. The device according to claim 14, wherein the at least one damping element is part of the sealing plate and is formed of elastic material.

16. The device according to claim 1, wherein the valve seat is an overhanging substantially blade-like annular seat.

17. The device according to claim 1, wherein the magnetic core contains at least one spring which is supported and centered on the magnetic core on one side, and on the valve element on the other side, and the at least one spring is a closing spring and applies a counterpressure.

18. The device according to claim 11, wherein the outlet channel which leads into the opening in the valve seat is sealed at an end of the valve body with an axial seal, with respect to a receptacle in the housing which contains an adjacent fluid outlet.

19. The device according to claim 11, wherein the at least one inlet channel of the valve body is connected to at least one supply channel in the valve body, which is connected to a fluid inlet in the housing.

20. The device according to claim 19, the valve body contains a circumferential seal, in a respective annular groove on either axial side of a supply channel, for sealing the valve body with respect to a receptacle in the housing, into which the valve body has been inserted.

21. The device according to claim 1, wherein the valve body has a stepped design and, in an axial region extending above a supply channel, has a larger diameter than in an axial region extending below a supply channel.

22. The device according to claim 1, wherein the medium is a reductant for an SCR exhaust gas treatment device.

23. The device according to claim 11, wherein the outlet channel is a central outlet channel, of which the outlet opening leads into the valve compartment.

24. The device according to claim 15, wherein the elastic material of the at least one damping element is an elastomer.

25. The device according to claim 17, wherein the at least one spring is a cylindrical coil spring.

26. The device according to claim 20, wherein the circumferential seal is a sealing ring.

27. The device according to claim 22, wherein the reductant is a urea-water solution.
